(19) United States
(12) Patent Application Publication
(10) Pub. No.: US 2019/0360954 A1
(43) Pub. Date: Nov. 28, 2019

(54) INFORMATION PROCESSING APPARATUS AND HEAT DENSITY CALCULATION METHOD

(71) Applicant: FUJITSU LIMITED, Kawasaki-shi (JP)

(72) Inventors: Tetsuyuki Kubota, Yokohama (JP); Akira Sakai, Kawasaki (JP)

(73) Assignee: FUJITSU LIMITED, Kawasaki-shi (JP)

(21) Appl. No.: 16/401,125

(22) Filed: May 2, 2019

(30) Foreign Application Priority Data
May 23, 2018 (JP) 2018-098794

(51) Int. Cl. G01N 25/20; G01K 3/14

(52) U.S. Cl. CPC G01N 25/20; G01K 3/14

(57) ABSTRACT

An information processing apparatus calculates a first temperature of a temperature surface when a heat density of each of a plurality of heating cells is set to a first heat density, calculates a second temperature when heat densities of the plurality of heating cells are set to a second heat density obtained by adding a constant value to each of first heat densities, calculates a change coefficient according to a temperature difference between the first and second temperatures, determines a third heat density so that a third temperature becomes a desired target temperature, based on the change coefficient, determines a width of each of the plurality of heating cells, based on the third heat density, and changes a shape of each of the plurality of heating cells, based on the width by using mesh morphing.

### CROSS-REFERENCE TO RELATED APPLICATION

This application is based upon and claims the benefit of priority of the prior Japanese Patent Application No. 2018-098794, filed on May 23, 2018, the entire contents of which are incorporated herein reference.

### FIELD

The embodiments discussed herein are related to an information processing apparatus and a heat density calculation method.

### BACKGROUND

In the related art, a Joule heat treatment is known in which heating is performed on a heated member such as, for example, a metal member by using a heat source such as a heater made of Nichrome. In the Joule heat treatment, it is preferable to uniformly heat the heated member. For this reason, a thermal fluid analysis simulation is performed to estimate a temperature distribution during the Joule heat treatment of the heated member and calculate a heat density of the heat source and a temperature of the heated member heated by the heat source.

Related techniques are disclosed in, for example, Japanese Laid-open Patent Publication No. 2009-282748.

### SUMMARY

According to an aspect of the invention, an information processing apparatus includes a memory, and a processor coupled to the memory and configured to calculate a first temperature of a temperature surface partitioned into a plurality of temperature cells associated with a plurality of heating cells partitioning a heating surface, respectively, one-to-one when a heat density of each of the plurality of heating cells is set to a first heat density, store the first temperature of each of the plurality of temperature cells, calculate a second temperature of the temperature surface when heat densities of the plurality of heating cells are set to a second heat density obtained by adding a constant value to each of first heat densities, store the second temperature of each of the plurality of temperature cells, calculate a change coefficient indicating a change amount of a temperature for a change amount of a heat density with respect to each of the plurality of heating cells according to a temperature difference between the first temperature and the second temperature of each of the plurality of temperature cells, determine a third heat density of each of the plurality of heating cells so that a third temperature of each of the plurality of temperature cells becomes a desired target temperature, based on the change coefficient, determine a width of each of the plurality of heating cells, based on the third heat density of each of the plurality of heating cells, and change a shape of each of the plurality of heating cells, based on the width of each of the plurality of heating cells by using mesh morphing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1F are diagrams for describing a heat density calculation method according to a first embodiment, in which FIG. 1A is a flowchart illustrating a process of the heat density calculation method according to the first embodiment, FIG. 1B is a first diagram for describing processes of S901 and S902, FIG. 1C is a second diagram for describing the process of S902, FIG. 1D is a diagram for describing a heat density of a heating cell which is increased by a predetermined amount when executing a second simulation, FIG. 1E is a third diagram for describing the process of S902, and FIG. 1F is a fourth diagram for describing the process of S902;

FIGS. 2A and 2B are block diagrams of an information processing apparatus according to the first embodiment, in which FIG. 2A is a circuit block diagram of the information processing apparatus according to the first embodiment, and FIG. 2B is a functional block diagram of a processing unit illustrated in FIG. 2A;

FIG. 3 is a flowchart of a simulation model generation process of the information processing apparatus according to the first embodiment;

FIGS. 4A to 4F are diagrams illustrating an example of a partitioning process of a heating body, in which FIG. 4A is a diagram for describing a process of S101, FIG. 4B is a diagram for describing a process of S102, FIG. 4C is a diagram for describing a process of S103, FIG. 4D is a diagram for describing a process of S104, FIG. 4E is a diagram for describing a process of S105, and FIG. 4F is a diagram illustrating a heating surface and a temperature surface which are associated with each other one by one;

FIG. 5 is a flowchart illustrating a heat density calculation process according to the first embodiment;

FIG. 6 is a diagram for describing a thermal fluid analysis simulation according to the first embodiment;

FIGS. 7A and 7B are diagrams for describing operational effects of the heat density calculation process according to the first embodiment, in which FIG. 7A is a diagram for describing the heat density calculation method according to the first embodiment, and FIG. 7B is a diagram for describing a difference between the heat density calculation method according to the first embodiment and a heat density calculation method by a heat response matrix method;

FIGS. 8A to 8C are diagrams illustrating an example of a heat density calculation result according to the first embodiment, in which FIG. 8A is a diagram illustrating an example of the heat density calculation result by the heat density calculation method according to the first embodiment, FIG. 8B is a diagram illustrating the heat density calculation result by the heat density calculation method according to the first embodiment when a heating cell is changed, and FIG. 8C is a diagram illustrating a comparison result of the number of execution times of the thermal fluid analysis simulation between the heat density calculation method according to the first embodiment and the heat density calculation method by the heat response matrix method;

FIG. 9 is a block diagram of an information processing apparatus according to a second embodiment;

FIG. 10 is a diagram illustrating an example of a storage unit according to the second embodiment;

FIG. 11 is a functional block diagram of a processing unit according to the second embodiment;

FIG. 12 is a flowchart illustrating a flow of a heat density calculation process according to the second embodiment;

FIG. 13 is a diagram illustrating an example of partitioning of a heating wire;

FIG. 14 is a diagram illustrating an example of a moving process for each partitioned area of the heating wire;

FIGS. 15A and 15B are diagrams illustrating an example of a shape changing process for each partitioned area of the heating wire according to the second embodiment;

FIG. 16 is a flowchart illustrating a detailed flow of the heat density calculation process according to the second embodiment; and

FIG. 17 is a diagram illustrating an example of area data.

### DESCRIPTION OF EMBODIMENTS

In a thermal fluid analysis, for example, the number of heat sources, a position, a wiring, and a calorific value are adjusted such that a heated member is uniformly heated based on a simulation result. Here, it is considered to partition a heat generation surface of a planar heat source into a plurality of heating cells and adjust the temperature of a temperature surface of the heated member heated by a heating surface to a desired temperature. In this case, an adjustment degree may be enhanced by increasing the number of heating cells that partition the heating surface.

However, as the number of heating cells increases, adjustment of a width of the wiring serving as the heat source becomes more complicated, and high density adjustment becomes difficult in some cases.

Hereinafter, embodiments of a technique capable of calculating a heat density with high accuracy in consideration of the width of the heating cell will be described in detail with reference to the accompanying drawings. Further, the disclosed technique is not limited by the following embodiments. In addition, the following embodiments may be appropriately combined within a compatible scope.

### First Embodiment

### Heat Density Calculation Method of First Embodiment

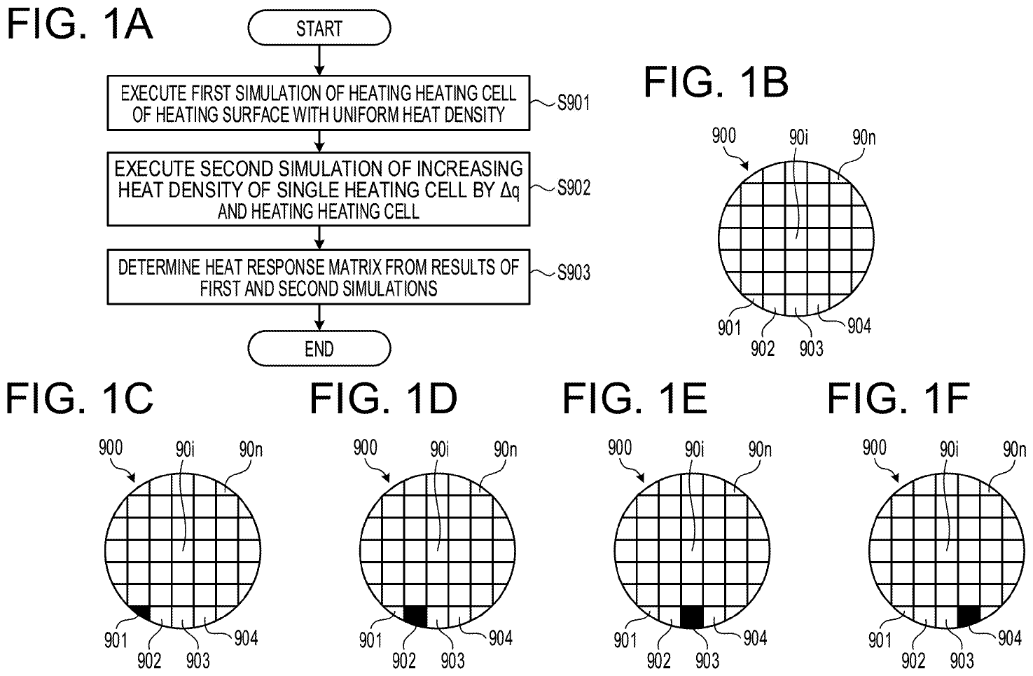

FIGS. 1A to 1F are diagrams for describing a heat density calculation method according to a first embodiment. FIG. 1A is a flowchart illustrating a process of the heat density calculation method according to the first embodiment. FIG. 1B is a first diagram for describing processes of S901 and S902. FIG. 1C is a second diagram for describing the process of S902. FIG. 1D is a diagram for describing a heat density of a heating cell which is increased by a predetermined amount when executing a second simulation. FIG. 1E is a third diagram for describing the process of S902. FIG. 1F is a fourth diagram for describing the process of S902.

The heat density calculation method according to the first embodiment is a modification of the heat response curve method and is also referred to as a heat response matrix method. The heat response curve method which approximates in an equation representing a surface temperature response curve which is a physical quantity of an output for a heat density which is a physical quantity of an input and solves an equation representing the surface temperature response curve with respect to the physical quantity of the input, calculates the physical quantity of the input to be targeted. An example representing the surface temperature response curve in the heat response curve method is represented in Equation (1) below.

$$( \begin{matrix}Δ {T}_{1} \\ ⋮ \\ Δ {T}_{i} \\ ⋮ \\ Δ {T}_{n}\end{matrix} ) = ( {A}_{ij} ) ( \begin{matrix}Δ {Q}_{1} \\ ⋮ \\ Δ {Q}_{i} \\ ⋮ \\ Δ {Q}_{n}\end{matrix} ) + ( {A}_{ij} ) {( \begin{matrix}Δ {Q}_{1} \\ ⋮ \\ Δ {Q}_{i} \\ ⋮ \\ Δ {Q}_{n}\end{matrix} )}^{2} … \qquad ( 1 )$$

In the heat response matrix method, the physical quantity of the input is calculated assuming that the physical quantity of the output is linear with respect to the physical quantity of the input, by ignoring the second and subsequent terms as an equation representing the response curve. An example representing the surface temperature response curve in the heat response matrix method is represented in Equation (2).

$$( \begin{matrix}Δ {T}_{1} \\ ⋮ \\ Δ {T}_{i} \\ ⋮ \\ Δ {T}_{n}\end{matrix} ) = ( {A}_{ij} ) ( \begin{matrix}Δ {Q}_{1} \\ ⋮ \\ Δ {Q}_{i} \\ ⋮ \\ Δ {Q}_{n}\end{matrix} ) \qquad ( 2 )$$

In the heat response matrix method, a heat response matrix Aij is calculated by executing the processes of S901 to S903 illustrated in FIG. 1A by an information processing apparatus (not illustrated). First, the information processing apparatus executes a first simulation by setting all heat densities of heating cells of a heating surface 900 partitioned into a plurality of heating cells 901 to 90n to a heat density Q0 (S901). The first simulation is a thermal fluid analysis simulation also called CFD.

In S901, heat densities q1 to qn of the plurality of respective heating cells 901 to 90n are Q0. When executing the first simulation, the information processing apparatus acquires temperatures T01 to T0n of temperature cells (not illustrated) which are associated one by one with the plurality of heating cells 901 to 90n, respectively. The plurality of temperature cells is formed by partitioning a target temperature surface (not illustrated).

Next, the information processing apparatus executes a second simulation in a state in which the heat density of a single heating cell is increased by Δq (S902). The second simulation is a thermal fluid analysis simulation similarly to the first simulation. First, as illustrated in FIG. 1C, the information processing apparatus increases the heat density of the heating cell of the heating cell 901 by Δq, sets the heat density to (Q0+Δq), and sets the heat densities of the heating cells 902 to 90n to Q0 to execute the second simulation of the first time. The information processing apparatus acquires temperatures T11 to Tin of the heating cells when executing the second simulation of the first time.

Next, as illustrated in FIG. 1D, the information processing apparatus increases the heat density of the heating cell 902 by Δq, sets the heat density to (Q0+Δq), and sets the heat densities of the heating cells 901 and 903 to 90n to Q0 to execute the second simulation of the second time. The information processing apparatus acquires temperatures T21 to T2n of the temperature cells when executing the second simulation of the second time.

Hereinafter, similarly, the information processing apparatus sequentially increases the heat densities of the heating cells 903 and 904 to execute the second simulation of the third and fourth times as illustrated in FIGS. 1E and 1F. The information processing apparatus acquires temperatures T31 to T3n and T41 to T4n of the temperature cells when executing the second simulation of the third and fourth times. The information processing apparatus increases the heat density of the heating cell of the heating cell 90i by Δq, sets the heat density to (Q0+Δq), and sets the heat densities of the heating cells 901 to 90(i−1)n and 90(i+1) to 90n to Q0 to execute the second simulation of an i-th time. The information processing apparatus acquires temperatures Ti1 to Tin of the temperature cells when executing the second simulation of the i-th time.

The information processing apparatus increases the heat density of the heating cell of the heating cell 90n by Δq, sets the heat density to (Q0+Δq), and sets the heat densities of the heating cells 901 to 90(n−1)n to Q0 to execute the second simulation of an n-th time. The information processing apparatus acquires temperatures Tn1 to Tnn of the temperature cells when executing the second simulation of the n-th time.

Next, the information processing apparatus determines the heat response matrix Aij from the results of the first simulation and the second simulation (S903). The information processing apparatus sequentially determines an element aij of the heat response matrix Aij. The element aij is calculated from a temperature Tij of the temperature cell corresponding to the heating cell 90j when increasing a calorific value of the heating cell 90i by Δq, the temperature Toi of the temperature cell corresponding to the heating cell 90i in the first simulation, and Δq by the following equations.

Aij=(Tij−Toi)/Δq

∵Tij−Toi=aij·Δq.

The information processing apparatus calculates temperature change amounts ΔT1 to ΔTn from ΔTi=Tij−Toj. The information processing apparatus calculates a change amount ΔQi (=Qi−Q0) of the heat density by solving Equation (2) of the obtained heat response with respect to the temperature change ΔTi.

In the heat response matrix method, after the first simulation that heats the heating surface 900 at a uniform heat density Q0 is executed, the second simulation of n times, which heats each of n heating cells 901 to 90n by increasing the heat density by Δq is executed. The number of execution times of the thermal fluid analysis simulation executed in the heat response matrix method becomes (n+1) as the sum of the first time of the first simulation and n times of the second simulation. In the heat response matrix method, since the number of execution times of the thermal fluid analysis simulation increases as the number n of heating cells partitioning the heating surface increases, cost of a heat density calculation process increases as the number n of heating cells increases.

### Overview of Information Processing Apparatus of First Embodiment

The information processing apparatus of the first embodiment executes the first simulation by setting the heat density of the heating surface to a first heat density and then, executes the second simulation by setting the heat density of the heating surface to a second heat density obtained by adding a constant value to the first heat density. The information processing apparatus of the first embodiment calculates a change coefficient indicating a change amount of a temperature for a change amount of the heat density with respect to each of a plurality of heating cells from a difference between a plurality of respective temperature cells corresponding to first temperature information and second temperature information. In addition, the information processing apparatus according to the first embodiment determines the heat density of each of the plurality of heating cells so that the temperature of each of the plurality of temperature cells becomes a desired target temperature based on the change coefficient. The information processing apparatus according to the first embodiment may calculate the heat density with higher precision at the smaller number of simulation execution times by determining the heat density of each of the plurality of heating cells based on the change coefficient indicating the change amount of the temperature for the change amount of the heat density.

### Configuration and Function of Information Processing Apparatus of First Embodiment

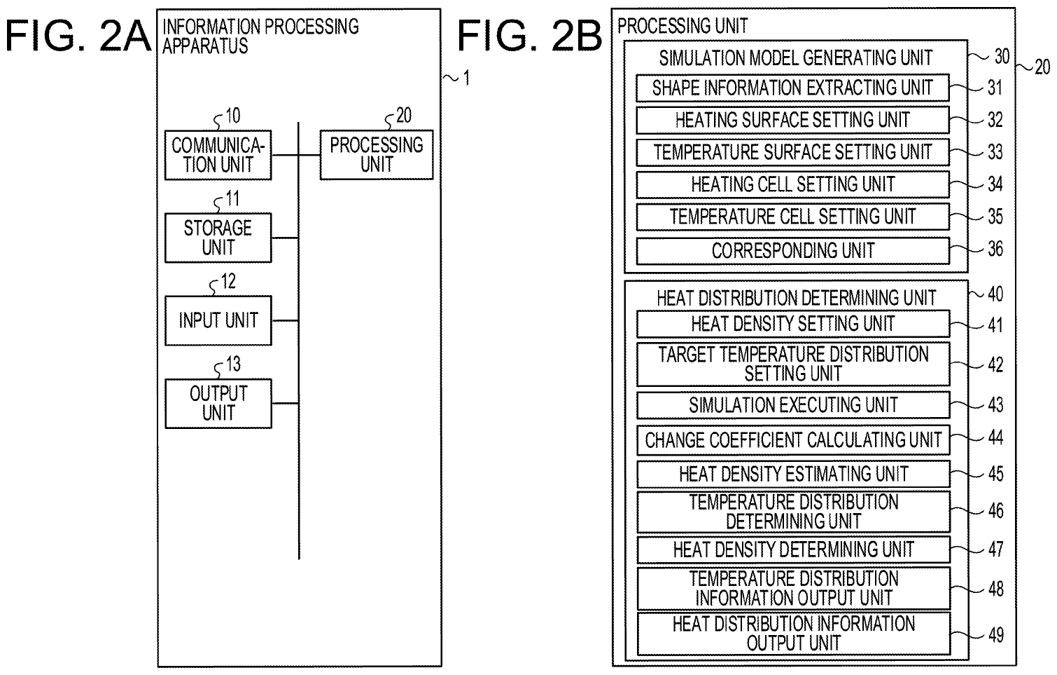

FIGS. 2A and 2B are block diagrams of an information processing apparatus according to the first embodiment. FIG. 2A is a circuit block diagram of the information processing apparatus according to the first embodiment. FIG. 2B is a functional block diagram of a processing unit installed in the information processing apparatus according to the first embodiment.

The information processing apparatus 1 includes a communication unit 10, a storage unit 11, an input unit 12, an output unit 13, and a processing unit 20.

The communication unit 10 communicates with, for example, a server (not illustrated) through the Internet according to a protocol of secure SHell (SSH). In addition, the communication unit 10 supplies data received from, for example, the server to the processing unit 20. In addition, the communication unit 10 transmits the data supplied from the processing unit 20 to, for example, the server.

The storage unit 11 includes, for example, at least one of a semiconductor device, a magnetic tape device, a magnetic disk device, and an optical disk device. The storage unit 11 stores, for example, an operating system program, a driver program, an application program, and data used for a process in the processing unit 20. For example, the storage unit 11 stores a simulation model generation program that executes a simulation model generation process which generates a simulation model of a thermal fluid analysis simulation as the application program by the processing unit 20. Further, the storage unit 11 stores a heat density calculation program that executes a heat density calculation process of calculating a heat density in which a temperature of a temperature surface becomes a desired target temperature as the application program by the processing unit 20. The heat density calculation program may be installed in the storage unit 11 from a computer-readable portable recording medium such as, for example, CDROM or DVD-ROM by using, for example, a known set-up program.

The storage unit 11 stores, for example, data used in an input process as data. In addition, the storage unit 11 may temporarily store data temporarily used in the process such as, for example, the input process.

The input unit 12 may be any device as long as data may be input, such as, for example, a touch panel or a key button. An operator may input, for example, letters, numbers, and symbols using the input unit 12. When the input unit 12 is operated by the operator, the input unit 12 generates a signal corresponding to the operation. In addition, the generated signal is supplied to the processing unit 20 by an instruction of the operator.

The output unit 13 may be any device as long as the output unit 13 may display an image or a frame and be, for example, a liquid crystal display or an organic electro-luminescence (EL) display. The output unit 13 displays an image depending on image data supplied from the processing unit 20 or the frame depending on moving picture data. Further, the output unit 13 may be an output device which prints the image, the frame, or the letter in a display medium such as, for example, paper.

The processing unit 20 has one or more processors and peripheral circuits thereof. The processing unit 20 collectively controls an overall operation of the information processing apparatus 1 and is, for example, a CPU. The processing unit 20 executes the process based on the program stored in the storage unit 11 (e.g., a driver program, an operating system program, or an application program). Further, the processing unit 20 may execute a plurality of programs (e.g., an application program) in parallel.

The processing section 20 has a simulation model generating unit 30 and a heat distribution determining unit 40. The simulation model generating unit 30 includes a shape information extraction unit 31, a heating surface setting unit 32, a temperature surface setting unit 33, a heating cell setting unit 34, a temperature cell setting unit 35, and a corresponding unit 36. The heat distribution determining unit 40 includes a heat density setting unit 41, a target temperature distribution setting unit 42, a simulation executing unit 43, a change coefficient calculating unit 44, a heat density estimation unit 45, a temperature distribution determining unit 46, and a heat density determination unit 47. The heat distribution determining unit 40 further includes a temperature distribution information output unit 48 and a heat distribution information output unit 49. Each of the units is a functional module implemented by a program executed by a processor included in the processing unit 20. Alternatively, each unit as firmware may be mounted on the information processing apparatus 1.

### Simulation Model Generation Process by Information Processing Apparatus of First Embodiment

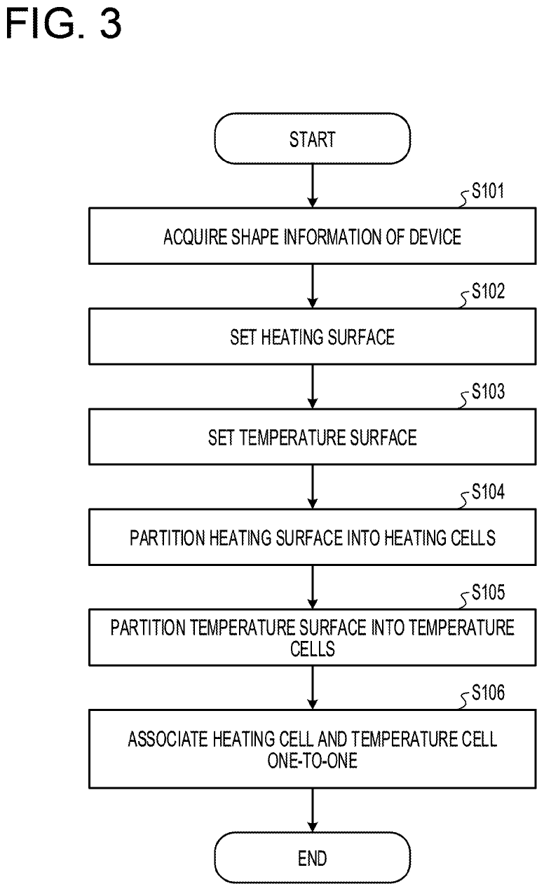

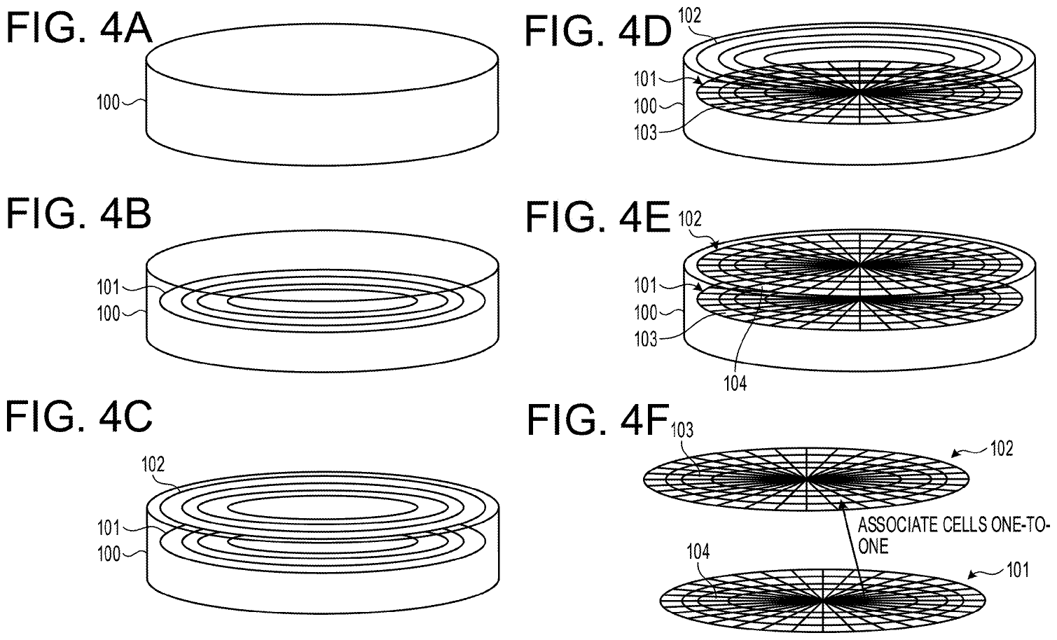

FIG. 3 is a flowchart of a simulation model generation process of the information processing apparatus according to the first embodiment. FIGS. 4A to 4F are diagrams illustrating an example of a partitioning process of a heating element. FIG. 4A is a diagram for describing a process of S101. FIG. 4B is a diagram for describing a process of S102. FIG. 4C is a diagram for describing a process of S103. FIG. 4D is a diagram for describing a process of S104. FIG. 4E is a diagram for describing a process of S105. FIG. 4F is a diagram illustrating a heating surface 101 and a temperature surface 102 which are associated with each other one by one. The simulation model generation process illustrated in FIG. 3 is executed mainly by the processing unit 20 in cooperation with each element of the information processing apparatus 1 based on the program stored in advance in the storage unit 11.

First, the shape information extraction unit 31 extracts shape information indicating a shape of a target device for which the heat density is to be calculated from a Computer Aided Design (CAD) model of the target device (S101). In the examples illustrated in FIGS. 4A to 4F, the shape of the target device 100 corresponding to the shape information is a cylindrical shape. The target device for which the heat density calculation process is executed is, for example, a heating device such as, for example, an electric hot plate.

Next, the heating surface setting unit 32 sets the heating surface to the shape of the target device extracted in the process of S101 (S102). In the examples illustrated in FIGS. 4A to 4F, the heating surface 101 is set as a circular plane in the device 100. The heating surface 101 is set according to the operation of the input unit 12 of an operator (not illustrated).

Next, the temperature surface setting unit 33 sets the temperature surface to the shape of the target device extracted in the process of S101 (S103). In the examples illustrated in FIGS. 4A to 4F, the temperature surface 102 is set as a circular plane on an upper surface of the device 100. The shape of the temperature surface 102 is the same as the shape of the heating surface 101 and an area of the temperature surface 102 is the same as the area of the heating surface 101. The temperature surface 102 is set according to the operation of the input unit 12 of an operator (not illustrated).

The simulation model generating unit 30 and the heat distribution determining unit 40 partition the temperature surface 102 and the heating surface 101 into a plurality of regions and adjust the calorific value of each region so as to obtain a desired temperature distribution in each region (hereinafter, also referred to as a secant method). Specifically, the heating cell setting unit 34 partitions the heating surface 101 set in the process of S102 to set a plurality of heating cells (S104). In the examples illustrated in FIGS. 4A to 4F, the heating cell 103 partitions the circular heating surface 101 into concentric circles having different diameters and concentric circles partitioned by a plurality of straight lines passing through the center of the heating surface 101 are further partitioned into fan shapes. The heating cell 103 is set according to the operation of the input unit 12 of an operator (not illustrated).

Next, the temperature cell setting unit 35 partitions the temperature surface 102 set in the process of S103 to set a plurality of temperature cells (S105). In the examples illustrated in FIGS. 4A to 4F, the temperature cell 104 partitions the circular temperature surface 102 into concentric circles having different diameters and concentric circles partitioned by a plurality of straight lines passing through the center of the temperature surface 102 are further partitioned into fan shapes. The number of temperature cells 104 is the same as the number of heating cells 103 and each of the plurality of temperature cells 104 formed on the heating surface 101 is the same as the shape of heating cell 103 formed at a location corresponding to the heating surface 101. The temperature cell 104 is set according to the operation of the input unit 12 of an operator (not illustrated).

The corresponding unit 36 makes the plurality of respective heating cells 103 set in the process of S104 correspond to the plurality of respective temperature cells 104 set in the process of S105 one by one (S106). In the examples illustrated in FIGS. 4A to 4F, each of the plurality of temperature cells 104 formed on the heating surface 101 corresponds to the heating cells 103 formed at a location corresponding to the heating surface 101. The corresponding unit 36 associates the temperature cell 104 and the temperature cell 104 which correspond to each other one by one to be stored in the storage unit 11 as a corresponding table.

Table 1 below represents an example of storage contents of the corresponding table stored in the storage unit 11.

TABLE 1

| | Cell Number | | | | |
|---|---|---|---|---|---|
| | 1 | 2 | 3 | . . . | n |
| Temperature (° C.) | 50 | 65 | 76 | . . . | 63 |
| Heat Density (W/cm²) | 1.2 | 2.3 | 3.2 | . . . | 7.5 |

### Heat Density Calculation Process by Information Processing Apparatus of First Embodiment

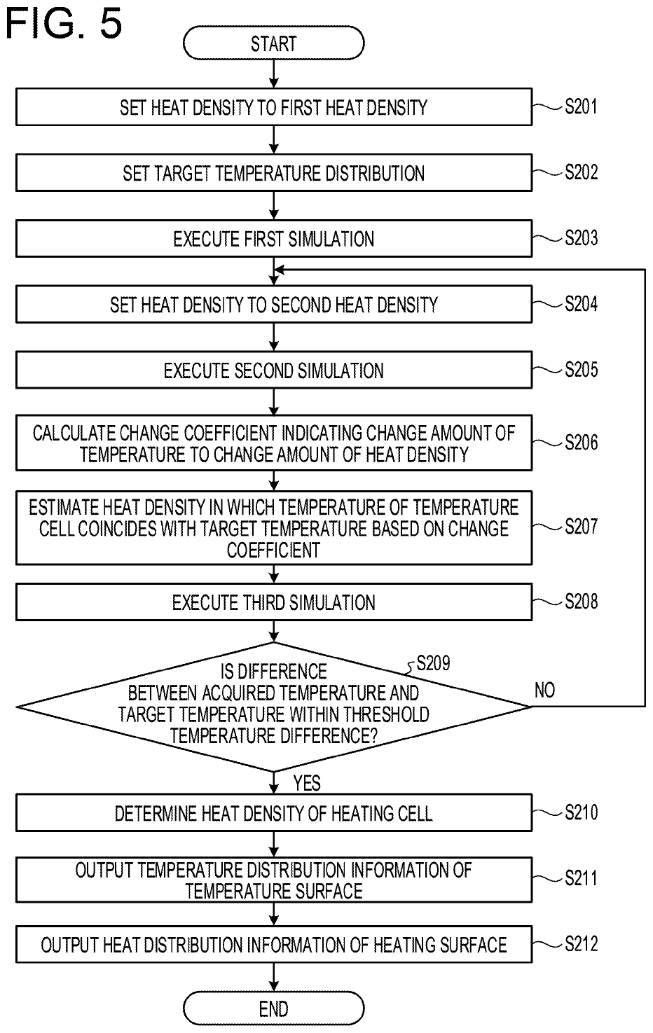

FIG. 5 is a flowchart illustrating a heat density calculation process according to the first embodiment. The heat density calculation process illustrated in FIG. 5 is executed mainly by the processing unit 20 in cooperation with each element of the information processing apparatus 1 based on the program stored in advance in the storage unit 11.

First, the heat density setting unit 41 sets all heat densities q0(i) of a plurality of heating cells to a first heat density q0 so that the heat density of the heating surface included in the simulation model generated by the simulation model generating unit 30 becomes uniform (S201). Next, the target temperature distribution setting unit 42 sets a target temperature distribution of the temperature surface included in the simulation model generated by the simulation model generating unit 30 (S202). The target temperature distribution setting unit 42 sets a target temperature Ttarget(i) of each of the temperature cells partitioning the temperature surface to set the target temperature distribution of the temperature surface. In an example, all of the target temperatures Ttarget(i) of each of the temperature cells are Ttarget and the target temperature distribution of the temperature surface is uniform over the entire temperature surface at the target temperature Ttarget.

Next, the simulation executing unit 43 executes a first simulation which is a thermal fluid analysis simulation, in a state in which all heat densities q0(i) of a plurality of heating cells are set to a first heat density q0 (S203). The simulation executing unit 43 stores first temperature information indicating the temperature T0(i) of each of the plurality of temperature cells calculated by executing the first simulation in the storage unit 11. The temperature of the first temperature cell is denoted by T0(1) and the temperature of the second temperature cell is denoted by T0(2), and the temperature of the nth temperature cell is denoted by T0(n).

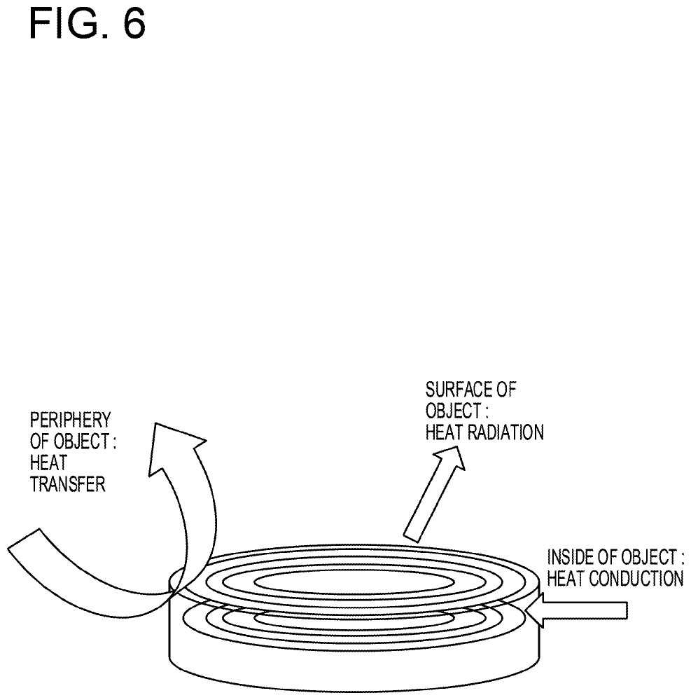

FIG. 6 is a diagram for describing a thermal fluid analysis simulation according to the first embodiment.

The thermal fluid analysis simulation is a simulation of calculating temperatures of a plurality of temperature cells included in the temperature surface by, for example, a finite difference method, a finite volume method, and a finite element method from a heat density of each of a plurality of heating cells included in the heating surface. In the thermal fluid simulation, the temperatures of the plurality of temperature cells are calculated by the heat density of each of the plurality of heating cells, a heat conduction inside an object, a heat transfer by the convection of air around the object, and an influence of the thermal radiation of the surface of the object.

Next, the heat density setting unit 41 sets the heat densities of all of the plurality of heating cells to a second heat density q1search(i) (=q0(i)+Δq) obtained by adding a constant value Δq to each of the first heat density q0(i) (S204). Heat densities q1search(1) to q1search(n) of first to nth heating cells are all set to (=q0+Δq). Next, the simulation executing unit 43 executes a second simulation which is the thermal fluid analysis simulation, in a state in which the heat densities of the plurality of heating cells are set to the second heat densities q1search(1) to q1search(n) (S205). The simulation executing unit 43 stores second temperature information indicating the temperature T1search(i) of each of the plurality of temperature cells calculated by executing the second simulation in the storage unit 11. The temperature of the first temperature cell is denoted by T1search(1) and the temperature of the second temperature cell is denoted by T1search(2), and the temperature of the nth temperature cell is denoted by T1search(n).

Next, the change coefficient calculating unit 44 calculates a change coefficient indicating a change amount of a temperature for a change amount of the heat density with respect to each of a plurality of heating cells from a difference between respective temperature cells of a plurality of temperature cells corresponding to first temperature information and second temperature information stored in the storage unit 11 (S206). The change coefficient calculating unit 44 calculates a change coefficient a1(i) by using Equation (3) below.

dⁿ(i)=(T_{search}ⁿ(i)−Tⁿ⁻¹(i)/Δq) (3)

In Equation (3), the symbol “n” represents “1” and the symbol “i” represents a cell number assigned to each of the plurality of temperature cells.

Next, the heat density estimating unit 45 estimates a third heat density q1(i) at which the temperature of the corresponding temperature cell coincides with the target temperature based on the change coefficient an(i) for each of the plurality of heating cells (S207). The heat density estimating unit 45 estimates the third heat density q1(i) at which the temperature of the corresponding temperature cell coincides with the target temperature using Equation (4) below.

$${q}^{n + 1} ( i ) = \frac{{T}_{target} ( i ) - {T}^{n - 1} ( i )}{{a}^{n} ( i )} + {q}^{n} ( i ) \qquad ( 4 )$$

In Equation (4), the symbol “n” represents “0” and the symbol “i” represents the cell number assigned to each of the plurality of temperature cells. T0(i) indicates the temperature corresponding to the first temperature information stored in the storage unit 11 and q0(i) indicates the heat density q0 of each of the plurality of heating cells.

Next, the simulation executing unit 43 executes a third simulation which is the thermal fluid analysis simulation, in a state in which all of the heat densities of the plurality of heating cells are set to a third heat density q1(i) which is estimated in the process of S207 (S208). The simulation executing unit 43 stores third temperature information indicating the temperature T1(i) of each of the plurality of temperature cells calculated by executing the third simulation in the storage unit 11. The temperature of the first temperature cell is denoted by T1(1) and the temperature of the second temperature cell is denoted by T1(2), and the temperature of the nth temperature cell is denoted by T1(n).

Next, the temperature distribution determining unit 46 determines whether a temperature difference between the temperature T1(i) of each of the plurality of temperature cells corresponding to the third temperature information and the target temperature Ttarget(i) of the plurality of temperature cells is within a predetermined threshold temperature difference (S209). When the temperature distribution determining unit 46 determines that the temperature difference between the temperature T1(i) of each of the plurality of temperature cells corresponding to the third temperature information and the target temperature Ttarget(i) of the plurality of temperature cells is not within the predetermined threshold temperature difference (“No” in S209), the process returns to S204.

When the process returns to S204, the heat density setting unit 41 sets the heat densities of the plurality of heating cells to a second heat density q2search(i) (=q1(i)+Δq) obtained by adding a constant value Δq to each of the third heat density q0(i) estimated in the process of S207 (S204). Next, the simulation executing unit 43 executes the second simulation (S205) and the change coefficient calculating unit 44 calculates a change coefficient a2(i) using Equation (3) (S206). Next, the heat density estimating unit 45 estimates the third heat density q1(i) using Equation (4) (S207) and the simulation executing unit 43 executes the third simulation (S208).

Until it is determined by the temperature distribution determining unit 46 that the temperature difference is within the predetermined threshold temperature difference (“Yes” in S209), the second heat density is set to qnsearch(i) (=qn−1(i)+Δq) and the processes of S204 to S209 are repeated.

When it is determined by the temperature distribution determining unit 46 that the temperature difference is within the predetermined threshold temperature difference (“Yes” in S209), the heat density determining unit 47 determines the third heat density qn(i) estimated last in the process of S207 as the heat density of the plurality of heating cells (S210).

Next, the temperature distribution information output unit 48 outputs the temperature Tn(i) of each of the plurality of temperature cells corresponding to the third temperature information last stored in the storage unit 11 as temperature distribution information of the temperature surface in the process of S208 (S211). Then, the heat distribution information output unit 49 outputs the heat density qn(i) of each of the plurality of heating cells determined in the process of S210 as heat distribution information of the heating surface (S212).

Steps S204 to S206 are heat density search routines of calculating a change coefficient indicating the amount of change in temperature with respect to the amount of change in heat density based on the execution result of the second simulation. Further, S207 to S209 are heat distribution change routines of determining the heat density of each of the plurality of heating cells so that the temperature of each of the plurality of temperature cells becomes a desired target temperature based on the change coefficient. [Operational Effects of Heat Density Calculation Method of First Embodiment]

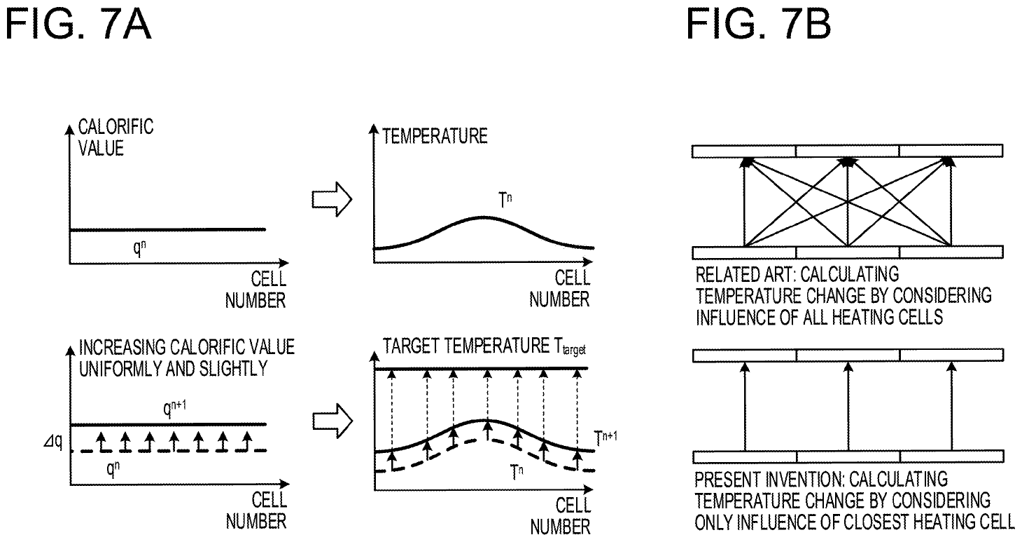

FIGS. 7A and 7B are diagrams for describing operational effects of the heat density calculation process according to the first embodiment. FIG. 7A is a diagram for describing the heat density calculation method according to the first embodiment. FIG. 7B is a diagram for describing a difference between the heat density calculation method according to the first embodiment and a heat density calculation method by a heat response matrix method.

In the heat density calculation method according to the first embodiment, the second heat densities of all of the heating cells are set to qnsearch(i) (=qn−1(i)+Δq) using the first heat density q0(i) or the third heat density qn(i) to execute the second simulation. In the heat density calculation method according to the first embodiment, the change coefficient a2(i) is calculated based on the execution result of the second simulation and the third heat density qn(i) is estimated using the calculated change coefficient an(i). In the heat density calculation method according to the first embodiment, until the temperature difference between the temperature Tn(i) of the temperature cell calculated by executing the third simulation and the target temperature Ttarget(i) is within a threshold temperature difference in a state where the heat density is set to the third heat density qn(i), the process is repeated. In addition, in the heat density calculation method according to the first embodiment, when the temperature difference between the temperature Tn(i) and the target temperature Ttarget(i) is within the threshold temperature difference, the temperature Tn(i) of the temperature cell is output as the temperature distribution information and the third heat density qn(i) is output as the heat distribution information.

In the heat density calculation method according to the first embodiment, in consideration of the influence of the closest heating cell associated one-to-one, the heat density is calculated while ignoring the influence of the heating cells other than heating cells associated one-to-one. In the meantime, in the heat density calculation method by the heat response matrix method, the heat density is calculated in consideration of the influence of all heating cells partitioning the heating surface. In the heat density calculation method according to the first embodiment, by ignoring the influence of the heating cells other than heating cells associated one-to-one, the number of simulation times for calculating the change coefficient a2(i) is reduced significantly compared with the heat density calculation method by the heat response matrix method.

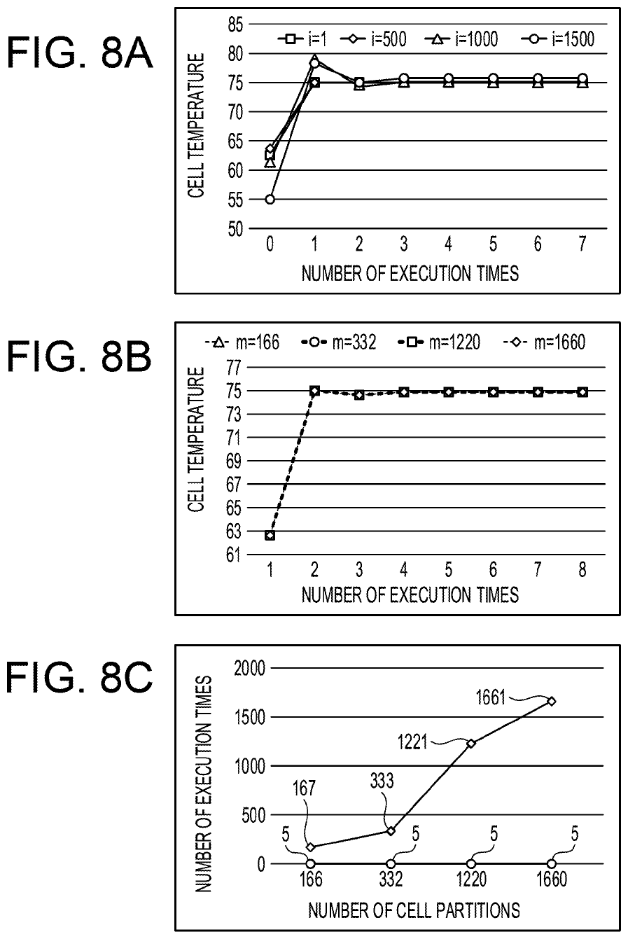

FIGS. 8A to 8C are diagrams illustrating an example of a heat density calculation result according to the first embodiment. FIG. 8A is a diagram illustrating an example of the heat density calculation result by the heat density calculation method according to the first embodiment in a case of forming the heating cells by partitioning a heating element 1660. FIG. 8B is a diagram illustrating the heat density calculation result by the heat density calculation method according to the first embodiment when a heating cell is changed. FIG. 8C is a diagram illustrating a comparison result of the number of execution times of the thermal fluid analysis simulation between the heat density calculation method according to the first embodiment and the heat density calculation method by the heat response matrix method.

In the example illustrated in FIG. 8A, each of the heating cell and the temperature cell has a structure in which a circular heating surface and a temperature surface of the same area are partitioned by concentric circles having different diameters and the concentric circles partitioned into a plurality of straight lines passing through the centers of the heating surface and the temperature surface are partitioned into fan shapes 1660 again. The first heating cell and the first temperature cell are located at the centers of the heating surface and the temperature surface, and cell numbers are assigned so that the cell numbers of the heating cell and the temperature cell increase as approaching an outer periphery. In FIG. 8A, the horizontal axis indicates the number of simulation execution times and the vertical axis indicates the temperature of the temperature cell, and the target temperature is 75° C. Further, in FIG. 8A, a square mark indicates the temperature of the temperature cell of cell number 1, a diamond mark indicates the temperature of the temperature cell of cell number 500, a triangle mark indicates the temperature of the temperature cell of cell number 1000, and a circle mark indicates the temperature of the temperature cell of cell number 1500.

Optimal solutions for the temperature of the first temperature cell located at the center of the temperature surface and the temperature of the 1500th temperature cell located at an outer peripheral portion of the temperature surface are obtained by executing a total of five simulations including the first simulation of one time and the second simulation and the third simulation of two times.

In the example illustrated in FIG. 8B, the heating surface and the temperature surface are partitioned into 166, 332, 1220, and 1660 heating cells and temperature cells, respectively. In FIG. 8B, the horizontal axis indicates the number of simulation execution times, the vertical axis indicates the temperature of the temperature cell, and the target temperature is 75° C. Further, in FIG. 8B, the square mark indicates the temperature of the temperature cell of cell number 1 when partitioned into 166 heating cells and the diamond mark indicates the temperature of the temperature cell of cell number 1 when partitioned into 332 heating cells. Further, the triangle mark indicates the temperature of the temperature cell of cell number 1 when partitioned into 1220 heating cells and the circle mark indicates the temperature of the temperature cell of cell number 1 when partitioned into 1660 heating cells.

In the heat density calculation method according to the first embodiment, even when the number of cell partitions is changed, the number of simulation execution times for calculating the heat density at which the temperature of the temperature cell located at the center of the temperature surface is an optimum temperature is not changed. Further, in the heat density calculation method according to the first embodiment, a history of the temperature of the temperature cell located at the center of the temperature surface is not changed even when the number of cell partitions is changed.

In the example illustrated in FIG. 8C, the heating surface and the temperature surface are partitioned into 166, 332, 1220, and 1660 heating cells and temperature cells, respectively. In FIG. 8C, the horizontal axis indicates the number of partitions of the temperature cell and the vertical axis indicates the number of simulation execution times. Further, in FIG. 8C, the circle mark indicates the number of execution times of the thermal fluid analysis simulation in the heat density calculation method according to the first embodiment and the diamond mark indicates the number of execution times of the thermal fluid analysis simulation in the heat density calculation method by the heat response matrix method.

The number of execution times of the thermal fluid analysis simulation in the heat density calculation method by the heat response matrix method increases in proportion to an increase of the number of partitions of the temperature cell. An execution time of the thermal fluid analysis simulation in the heat density calculation method by the heat response matrix method is generally several hours. In the heat density calculation method by the heat response matrix method, when the number of partitions of the temperature cell exceeds 1000 and the number of execution times of the thermal fluid analysis simulation exceeds 1000, there is a possibility that the heat density is not actually calculated. In the meantime, in the heat density calculation method according to the first embodiment, even when the number of partitions of the temperature cell exceeds 1000, the number of execution times of the thermal fluid analysis simulation does not increase from 5, so that even when the number of partitions of the temperature cell increases, there is no possibility that the heat density is not calculated.

### Modification of Heat Density Calculation Method of First Embodiment

In the heat density calculation method according to the first embodiment described above, the shapes of the heating surface and the temperature surface are assumed to be circular flat surfaces as an example, but the shapes of the heating surface and the temperature surface may be other shapes including, for example, a rectangular shape. Further, the heating surface and the temperature surface may have uneven portions such as, for example, screw holes instead of flat surfaces.

In the heat density calculation method according to the first embodiment described above, the shape of the heating surface and the shape of the temperature surface are the same, but in the heat density calculation method according to the first embodiment, the shapes of the heating surface and the temperature surface may be different from each other. In addition, in the above-described heat density calculation method, the shape of the heating cell is the same as the shape of the temperature surface associated one to one, but in the heat density calculation method according to the first embodiment, the shape of the heating cell may be different from the shape of the temperature surface associated one-on-one.

### Second Embodiment

The first embodiment is an example in which the heat density calculation process is performed by a secant method, but it is possible to perform a high-precision heat density calculation process by adjusting the width and shape of a heating wire of the heating element by combining the secant method and mesh morphing. The embodiment in this case will be described as a second embodiment. Further, the same components as those of the information processing apparatus 1 according to the first embodiment are denoted by the same reference numerals, and duplicate descriptions of the configurations and operations will be omitted.

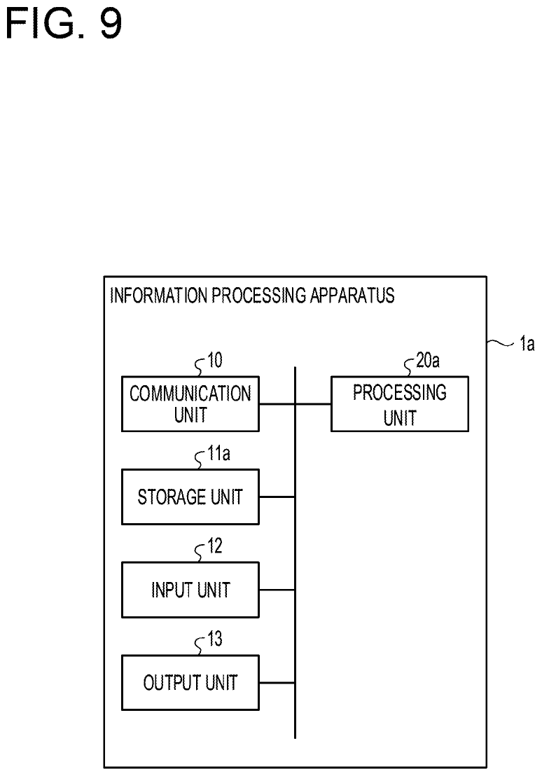

FIG. 9 is a block diagram of an information processing apparatus 1a according to a second embodiment. The information processing apparatus 1a includes a storage unit 11a and a processing unit 20a instead of the storage unit 11 and the processing unit 20 of the information processing apparatus 1 according to the first embodiment.

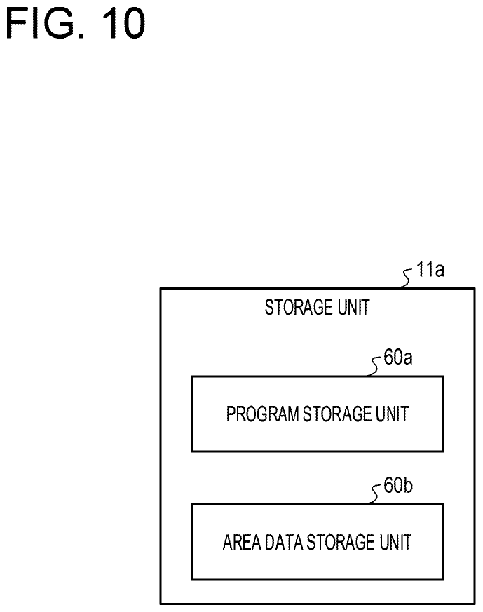

FIG. 10 is a diagram illustrating an example of the storage unit 11a according to the second embodiment. Compared with the storage unit 11, the storage unit 11a includes a program storage unit 60a which is a storage area of a heat density calculation program and an area data storage unit 60b which is a storage area of area data.

The heat density calculation program is a program that enables a high-precision calculation process of the heat density of the heating element by combining the secant method and the mesh morphing. The area data storage unit 60b stores area data such as a width change amount of each area formed by partitioning the heating wire based on the secant method (width change amount information) and a temperature difference for the target temperature (temperature difference information). Based on the width change amount information and the temperature difference information stored in the area data storage unit 60b, the information processing apparatus 1a gradually changes (adjusts) a line width and the shape of the heating wire so that the temperature difference with respect to the target temperature falls within a predetermined range.

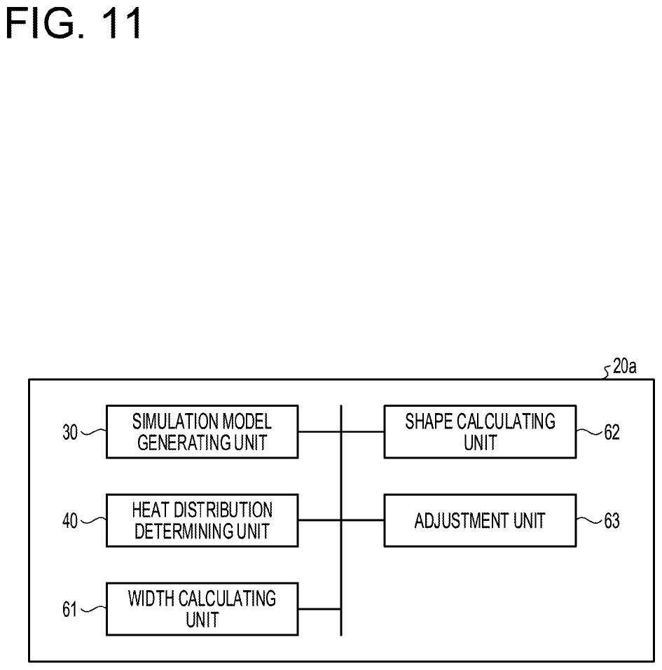

FIG. 11 is a functional block diagram of a processing unit 20a according to the second embodiment. The processing unit 20a further includes a width calculating unit 61, a shape calculating unit 62, and an adjustment unit 63, as compared with the processing unit 20.

The width calculating unit 61 calculates the width of each area of the heating wire partitioned by the secant method (an example of a heating cell) based on a fact that a heating value and a heating wire width are proportional. The shape calculation unit 62 calculates the shape of the heating wire using the mesh morphing. The adjustment unit 63 controls the simulation model generating unit 30, the heat distribution determining unit 40, the width calculating unit 61, and the shape calculating unit 62 so as to gradually change (adjust) the line width and the shape of the heating wire until the temperature difference with respect to the target temperature of each area falls within a predetermined range.

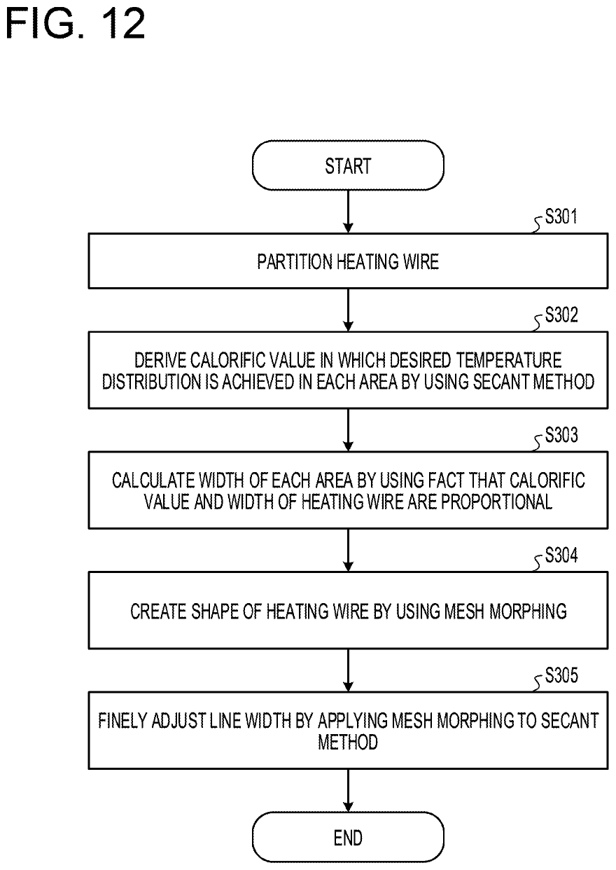

FIG. 12 is a flowchart illustrating a flow of a heat density calculation process according to the second embodiment. The processing unit 20a starts the process of the flowchart of FIG. 12 from the operation S301 by detecting an execution start operation of the heat density calculation process by an operator. In operation S301, the simulation model generating unit 30 partitions the heating surface 101 of the heating element into the plurality of heating cells 103 as described with reference to FIGS. 4A to 4F. Further, hereinafter, each of the heating cells 103 formed by partitioning is referred to as “area”.

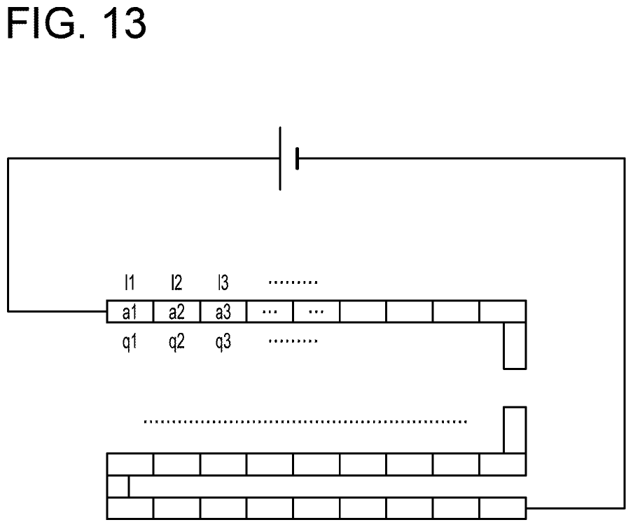

FIG. 13 is a diagram illustrating an example of partitioning of a heating wire. FIG. 13 illustrates a heating element partitioned into respective areas. In the examples represented in FIGS. 4A to 4F, it is assumed that a cylindrical heating element is partitioned into a plurality of areas by the plurality of straight lines passing through the center. In the meantime, in the example of the second embodiment illustrated in FIG. 13, in order to facilitate understanding, for example, the heating element such as, for example, a linear heating wire in, for example, a straight line shape or a curved line shape is partitioned into each of areas a1, a2, a3, . . . , etc., which have a constant length (fixed length) in a longitudinal direction (extension direction).

A positive terminal of a power supply is connected to one terminal of the heating element, and a negative terminal of the power supply is connected to the other terminal of the heating element. In the example of FIG. 13, such a heating element is partitioned into respective areas a1, a2, a3, etc. Each area has a constant length (fixed length). That is, a partitioning position of each area is fixed. The calorific value of each area is adjusted by changing the width and shape of each area as described later.

In operation S302, as in the first embodiment, the heat distribution determining unit 40 calculates the calorific value that makes each area with a desired temperature distribution by using the secant method. Each process of operations S301 and S302 is the heat density calculation process using the secant method described in the first embodiment.

Next, in operation S303, the width calculating unit 61 illustrated in FIG. 11 calculates the width of each area by using a fact that the calorific value and the width of the heating wire are proportional to each other. Specifically, as illustrated in FIG. 13, the calorific values of the areas a1, a2, a3, etc., obtained by the secant method are set as calorific values q1, q2, q3, . . . , qi, . . . , qn, respectively. The symbol “n” represents the number of partitions (the number of areas) of the heating element.

The width calculating unit 61 calculates a ratio of the line widths of the respective areas, which is an inverse ratio of the calorific value, by performing the calculation of Equation (5) below. That is, the ratio of each line width in each area may be calculated as the inverse ratio of the calorific value.

d1=1/q1,d2=1/q2,d3=1/q3, . . . ,dn=1/qn (5)

Here, a maximum value among the ratios d1, d2, d3, . . . , dn of the respective line widths of the respective areas is denoted by “D”. Further, the widths of the heating elements in the respective areas are set as widths l1, l2, l3, . . . , li, . . . , ln. Further, an allowable value of the width of the heating element is denoted by “L”. The width calculating unit 61 calculates the width li of the heating element that implements the calorific value calculated in operation S302 by performing the calculation of Equation (6) below using calculation factors described above. The width li represents a value which is twice a distance depending on a width direction of the heating element from a center line formed in an extending installation direction of the heating element by sequentially connecting adjacent center points among respective center points located at the center of the width direction of the heating element up to the outer peripheral portion of the heating element at each position in the extending installation direction of the heating element. In addition, the width li may be, for example, a distance based on one boundary (outer peripheral portion) in the width direction of each area.

li=L×(di/D) (6)

By performing such a calculation, the width li of the heating element required in each area may be determined while maintaining an upper limit (allowable value) of the width of the heating element.

Next, in operation S304, the shape calculating unit 62 calculates the shape of the heating wire using the mesh morphing and changes the shape of each area based on the calculation result. Further, as for a mesh object used for the mesh morphing, for example, a mesh object used in the above-described thermal fluid analysis simulation is used. The shape calculating unit 62 changes the shape of each area by moving a contact point of the mesh object corresponding to the outer peripheral portion of the heating cell so that the area has the above-described width li.

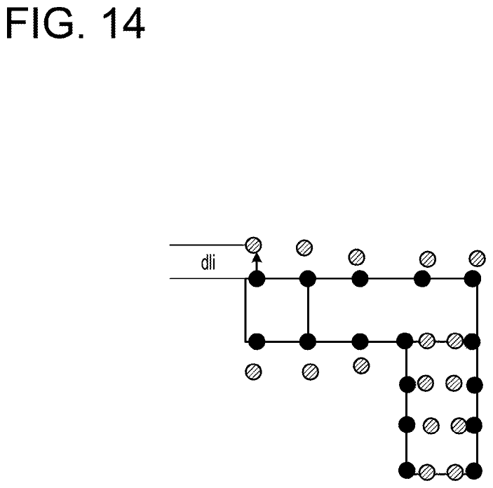

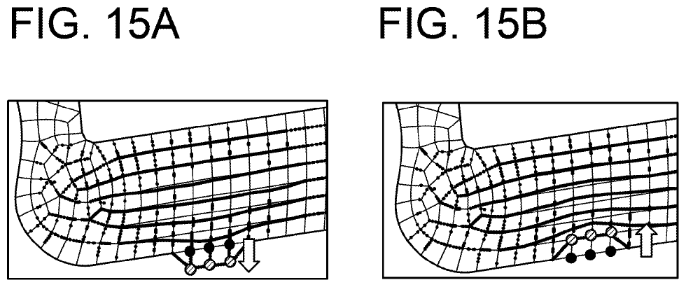

FIGS. 14, 15A, and 15B illustrate a state in which the shape of each area is changed. In the example of FIG. 14, a black circle indicates a contact point of the outer peripheral portion of the mesh object before the mesh morphing and a circle with slants indicates a position of a contact point after the mesh morphing. Further, the symbol “dli” represents a movement amount of the contact point, that is, the movement amount of the outer peripheral portion of the heating wire. As illustrated in FIGS. 14, 15A, and 15B, the shape calculating unit 62 moves the contact point of the outer peripheral portion of the mesh object so that the area has the above-described width li and changes the shape of each area.

Next, in operation S305, the adjustment unit 63 calculates the temperature difference with respect to the target temperature in each area. When the temperature difference in each area is out of a predetermined range, the adjustment unit 63 controls the width calculating unit 61 so as to calculate again the width of the heating wire of operation S302. Further, in addition thereto, the adjustment unit 63 controls the shape calculating unit 62 so as to calculate the shape of the heating wire again. The adjustment unit 63 repeats such recalculation control until the temperature difference in each area becomes within the predetermined range and adjusts the width and shape of each area.

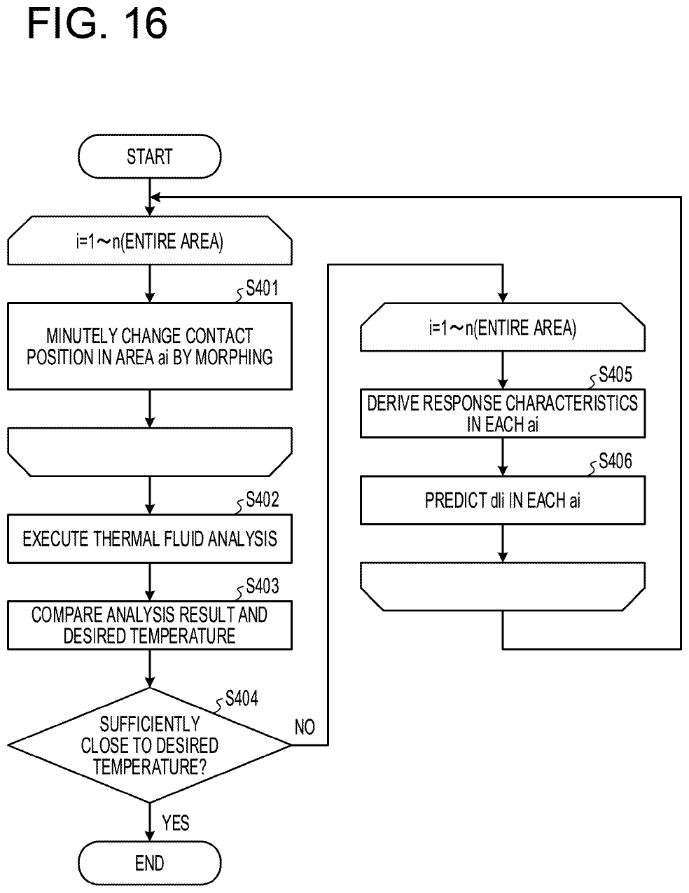

Next, the heat density calculation process will be described in detail with reference to FIG. 16. FIG. 16 is a flowchart illustrating a detailed flow of the heat density calculation process according to the second embodiment. In the flowchart of FIG. 16, as described in operations S301 to S303 of the flowchart of FIG. 11, the process starts by calculating the width of each area based on the secant method. When the process starts, first, the shape calculating unit 62 repeatedly executes the process of operation S401 for all partitioned areas and moves a contact position of the outer periphery of each area by using the mesh morphing.

Upon completing the process of moving the contact position by the mesh morphing with respect to the entire area, the heat distribution determining unit 40 executes the above-described thermal fluid analysis simulation in operation S402. Further, the thermal fluid analysis simulation is executed using the same mesh object as the mesh morphing as described above.

Next, in operation S403, the heat distribution determining unit 40 compares an analysis result by the thermal fluid analysis simulation with a desired temperature (target temperature) for each area. In addition, in operation S404, the heat distribution determining unit 40 determines whether the temperature of each area is sufficiently close to the desired temperature (target temperature) (whether the temperature is within a predetermined range).

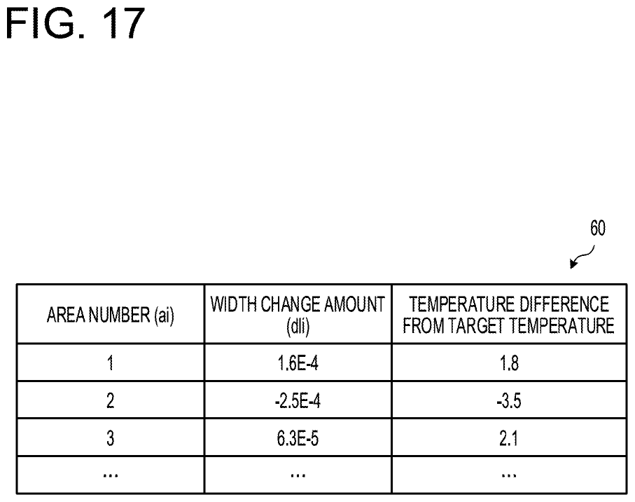

Here, as described above, as illustrated in FIG. 17, in the storage unit 11a, an area data storage unit 60b is installed which stores an area number of each area, a width change amount, and a temperature difference with respect to the target temperature to be associated with each other. Before the process of the flowchart of FIG. 16 starts, the change amount dli of the width of each area of the heating wire calculated based on the secant method is associated with the area number (ai (i is a natural number)) of each area and stored in the area data storage unit 60b. Further, the heat distribution determining unit 40 stores the temperature difference of each area detected in operation S404 in the area data storage unit 60b.

In the example of the area data storage unit 60b illustrated in FIG. 17, the area having the area number of “1” has a width change amount of 1.6E-4 mm (1.6×10⁻⁴ mm) and in this case, it is indicated that a temperature difference of 1.8° C. is generated. Further, the area having the area number of “2” has a width change amount of −2.5E-4 mm (−2.5×10⁻⁴ mm) and in this case, it is indicated that a temperature difference of −3.5° C. is generated. Similarly, the area having the area number of “3” has a width change amount of 6.3E-5 mm (6.3×10⁻⁵ mm) and in this case, it is indicated that a temperature difference of 2.1° C. is generated.

When such a temperature difference is within the predetermined range (“Yes” in operation S404), the processing unit 20a terminates all processes in the flowchart of FIG. 16. In this regard, when the temperature difference is out of the predetermined range (“No” in operation S404), the process proceeds to operations S405 and S406.

In operations S405 and S406, the heat distribution determining unit 40 calculates again the calorific value (response characteristic) of each area ai using the secant method. Further, the width calculating unit 61 calculates (predicts) the width di of each area based on the calculated calorific value of each area. The heat distribution determining unit 40 and the width calculating unit 61 repeatedly execute the processes with respect to the entire area. The heat distribution determining unit 40 calculates a difference between the width of each area calculated again and the width of each area of a design value and stores (updates) the difference in the area data storage unit 60b as the width change amount.

When the updating of the width change amount of the entire area by the heat distribution determining unit 40 and the width calculating unit 61 is completed, the process returns to operation S401. The shape calculating unit 62 performs a movement process of the contact position based on the updated width change amount by the mesh morphing again. The heat distribution determining unit 40 executes the thermal fluid analysis simulation based on the changed width and shape of each area. In addition, the heat distribution determining unit 40 detects the temperature difference for the target temperature for each area and updates the temperature difference of the area data storage unit 60b. Further, the heat distribution determining unit 40, the width calculating unit 61, and the shape calculating unit 62 repeat again the calculation of the width of each area using the secant method and the change of the width and shape of each area using the mesh morphing (operation S401) so that the temperature difference falls within the predetermined range (operations S405 and S406). Therefore, the information processing apparatus 1a may finely adjust a wiring width.

When the calorific value is adjusted by changing the width of the heating wire, a dimension and the position of the heating wire are changed. In addition, a bending portion where the heating wire is bent and wired according to the shape of the device 100 has a lower resistance than a linear portion where the heating wire is linearly wired even when the bending portion has the same line length. Due to these reasons, there is a possibility that a difference occurs in the temperature distribution of the heating surface 101 after adjustment.

In this regard, in the case of the information processing apparatus 1a, the width and shape of the heating wire are adjusted by combining the mesh morphing and the secant method. Therefore, the information processing apparatus 1a calculates the width and shape of each area of the heating wire with high accuracy, thereby enabling complicated adjustment of the wiring of the heating wire. Further, since the information processing apparatus 1a may calculate the width and shape of each area of the heating wire with high accuracy, it is possible to prevent as much troublesome work as repetition of wiring and adjustment. Further, the information processing apparatus 1a may implement an accurate line width.

As described above, the information processing apparatus 1a executes the first simulation that calculates the temperature of the temperature surface partitioned into the plurality of temperature cells associated with the plurality of heating cells when the heat density of each of the plurality of heating cells partitioning the heating surface is set to the first heat density one-to-one, respectively. The information processing apparatus 1a stores the first temperature information indicating the temperature of each of the plurality of temperature cells which is the execution result of the first simulation. Further, the information processing apparatus 1a executes the second simulation of calculating the temperature of the temperature surface when the heat densities of the plurality of heating cells are set to the second heat density obtained by adding a constant value to each of the first heat densities. The information processing apparatus 1a stores the second temperature information indicating the temperature of each of the plurality of temperature cells which is the execution result of the second simulation. Further, the information processing apparatus 1a calculates a change coefficient indicating a change amount of a temperature for a change amount of the heat density with respect to each of a plurality of heating cells from a difference between respective temperature cells of a plurality of temperature cells corresponding to first temperature information and second temperature information. In addition, the information processing apparatus 1a determines the heat density of each of the plurality of heating cells so that the temperature of each of the plurality of temperature cells becomes a desired target temperature based on the change coefficient. Further, the information processing apparatus 1a determines the width of each of the plurality of heating cells based on the determined heat density of each of the plurality of heating cells. In addition, the information processing apparatus 1a changes the shape of each of the plurality of heating cells based on the determined width of each of the plurality of heating cells by using the mesh morphing. As a result, the information processing apparatus 1a may calculate the heat density as a fixed density by considering the width of the heating cell.

When the temperature of the temperature cell measured after changing the shape of the heating cell does not become the target temperature, the information processing apparatus 1a repeats the process of determining the heat density, the process of determining the width, and the process of changing the shape until the temperature of the temperature cell reaches the target temperature. As a result, the information processing apparatus 1a may calculate the heat density as the fixed density according to the shape of each heating cell.

When the shape of each of the plurality of heating cells is changed using the mesh morphing, the information processing apparatus 1a changes the shape by moving the contact point of the mesh object corresponding to the outer peripheral portion of the heating cell. As a result, the information processing apparatus 1a may change the width of the heating cell.

The information processing apparatus 1a determines the width of each of the plurality of heating cells based on the change coefficient of each of the plurality of heating cells. As a result, the information processing apparatus 1a may change the width of the heating cell according to the response characteristics for each heating cell.

Each component of each unit illustrated in each embodiment needs not particularly be configured as physically illustrated. That is, a concrete form of distribution and integration of each unit is not limited to the illustration and all or a part of the units may be configured to be functionally or physically distributed and integrated by a predetermined unit according to various loads or use situations.

All or predetermined parts of various processing functions may be executed on a CPU (or a microcomputer such as, for example, an MPU or a micro controller unit (MCU)). In addition, all or predetermined parts of various processing functions may be executed on a program interpreted and executed by the CPU (or a microcomputer such as, for example, an MPU or a micro controller unit (MCU)) or hardware by a wired logic.

The above heat density calculation program needs not be particularly stored in the storage unit 11 or the storage unit 11a. For example, a program stored in a computer-readable storage medium may be read and executed by a computer. The storage medium readable by the computer corresponds to, for example, a portable recording medium such as, for example, a CD-ROM, a digital versatile disc (DVD), or a universal serial bus (USB) memory, a semiconductor memory such as, for example, a flash memory, or a hard disk drive. In addition, the heat density calculation program may be stored in a device connected to a public line, the Internet, or a LAN and the computer may read and execute a heat density calculation program from the device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
calculate a first temperature of a temperature surface partitioned into a plurality of temperature cells associated with a plurality of heating cells partitioning a heating surface, respectively, one-to-one when a heat density of each of the plurality of heating cells is set to a first heat density;
store the first temperature of each of the plurality of temperature cells;
calculate a second temperature of the temperature surface when heat densities of the plurality of heating cells are set to a second heat density obtained by adding a constant value to each of first heat densities;
store the second temperature of each of the plurality of temperature cells;
calculate a change coefficient indicating a change amount of a temperature for a change amount of a heat density with respect to each of the plurality of heating cells according to a temperature difference between the first temperature and the second temperature of each of the plurality of temperature cells;
determine a third heat density of each of the plurality of heating cells so that a third temperature of each of the plurality of temperature cells becomes a desired target temperature, based on the change coefficient;
determine a width of each of the plurality of heating cells, based on the third heat density of each of the plurality of heating cells; and
change a shape of each of the plurality of heating cells, based on the width of each of the plurality of heating cells by using mesh morphing.

2. The information processing apparatus according to claim 1,
wherein, when the temperature of the temperature cell measured after changing the shape of a heating cell of the plurality of heating cells does not become the target temperature, the processor repeatedly determines the third heat density and the width, and changes the shape until the third temperature becomes the desired target temperature.

3. The information processing apparatus according to claim 1,
wherein, when the shape of each of the plurality of heating cells is changed by using the mesh morphing, the processor changes the shape by moving a contact point of a mesh object corresponding to an outer peripheral portion of a heating cell of the plurality of heating cells.

4. The information processing apparatus according to claim 1,
wherein the processor determines the width of each of the plurality of heating cells, based on the change coefficient of each of the plurality of heating cells.

5. A non-transitory computer-readable recording medium storing a program that causes a computer to execute a procedure, the procedure comprising:
calculating a first temperature of a temperature surface partitioned into a plurality of temperature cells associated with a plurality of heating cells partitioning a heating surface, respectively, one-to-one when a heat density of each of the plurality of heating cells is set to a first heat density;
storing the first temperature of each of the plurality of temperature cells;
calculating a second temperature of the temperature surface when heat densities of the plurality of heating cells are set to a second heat density obtained by adding a constant value to each of first heat densities;
storing the second temperature of each of the plurality of temperature cells;
calculating a change coefficient indicating a change amount of a temperature for a change amount of a heat density with respect to each of the plurality of heating cells according to a temperature difference between the first temperature and the second temperature of each of the plurality of temperature cells;
determining a third heat density of each of the plurality of heating cells so that a third temperature of each of the plurality of temperature cells becomes a desired target temperature, based on the change coefficient;
determining a width of each of the plurality of heating cells, based on the third heat density of each of the plurality of heating cells; and
changing a shape of each of the plurality of heating cells, based on the width of each of the plurality of heating cells by using mesh morphing.

6. The non-transitory computer-readable recording medium according to claim 5,
wherein, when the temperature of the temperature cell measured after changing the shape of a heating cell of the plurality of heating cells does not become the target temperature, the procedure repeatedly determines the third heat density and the width, and changes the shape until the third temperature becomes the desired target temperature.

7. The non-transitory computer-readable recording medium according to claim 5,
wherein, when the shape of each of the plurality of heating cells is changed by using the mesh morphing, the procedure changes the shape by moving a contact point of a mesh object corresponding to an outer peripheral portion of a heating cell of the plurality of heating cells.

8. The non-transitory computer-readable recording medium according to claim 5,
wherein the procedure determines the width of each of the plurality of heating cells, based on the change coefficient of each of the plurality of heating cells.

9. A heat density calculation method comprising:
calculating a first temperature of a temperature surface partitioned into a plurality of temperature cells associated with a plurality of heating cells partitioning a heating surface, respectively, one-to-one when a heat density of each of the plurality of heating cells is set to a first heat density;
storing the first temperature of each of the plurality of temperature cells;
calculating a second temperature of the temperature surface when heat densities of the plurality of heating cells are set to a second heat density obtained by adding a constant value to each of first heat densities;
storing the second temperature of each of the plurality of temperature cells;
calculating a change coefficient indicating a change amount of a temperature for a change amount of a heat density with respect to each of the plurality of heating cells according to a temperature difference between the first temperature and the second temperature of each of the plurality of temperature cells;
determining a third heat density of each of the plurality of heating cells so that a third temperature of each of the plurality of temperature cells becomes a desired target temperature, based on the change coefficient;
determining a width of each of the plurality of heating cells, based on the third heat density of each of the plurality of heating cells; and
changing a shape of each of the plurality of heating cells, based on the width of each of the plurality of heating cells by using mesh morphing, by a processor.

10. The heat density calculation method according to claim 9,
wherein, when the temperature of the temperature cell measured after changing the shape of a heating cell of the plurality of heating cells does not become the target temperature, the processor repeatedly determines the third heat density and the width, and changes the shape until the third temperature becomes the desired target temperature.

11. The information processing apparatus according to claim 9,
wherein, when the shape of each of the plurality of heating cells is changed by using the mesh morphing, the processor changes the shape by moving a contact point of a mesh object corresponding to an outer peripheral portion of a heating cell of the plurality of heating cells.

12. The information processing apparatus according to claim 9,
wherein the processor determines the width of each of the plurality of heating cells, based on the change coefficient of each of the plurality of heating cells.
